(19) United States
(12) Patent Application Publication
(10) Pub. No.: US 2023/0234248 A1
(43) Pub. Date: Jul. 27, 2023

(54) Food Chopping Device

(71) Applicant: Williams-Sonoma, Inc., San Francisco, CA (US)

(72) Inventors: Karl Edward Ludeman, Oakland, CA (US); Megan Dittrich, Cleveland, OH (US)

(21) Appl. No.: 18/158,101

(22) Filed: Jan. 23, 2023

Related U.S. Application Data
(60) Provisional application No. 63/303,817, filed on Jan. 27, 2022.

(51) Int. Cl. B26B 9/00; B26B 3/00; A22C 17/00

(52) U.S. Cl. CPC B26B 9/00; B26B 3/00; A22C 17/0006

(57) ABSTRACT

A food chopping device is provided. The chopping device includes a chopping member having a pair of wings with each wing having a holding surface and a chopping edge. An angle is formed between the holding surfaces of the pair of wings. The chopping member also including an opening configured to drain a liquid from food. The food chopping device also includes a handle member attached with the chopping member.

### CLAIM OF PRIORITY

This application claims the benefit of U.S. Provisional Application No. 63/303,817, filed Jan. 27, 2022, the contents of which are hereby incorporated by reference.

### TECHNICAL FIELD

The present disclosure generally relates to food preparation tools. More particularly, the present disclosure relates to food chopping devices.

### BACKGROUND

Food chopping devices have been popular with both restaurant chefs and home cooks for chopping food items that are difficult to cut. A chopping device typically includes a plurality of chopping blades attached to a gripping member. Chopping devices on the market typically feature three or more chopping blades.

In chopping devices that feature three or more blades, it may be difficult to do anything else but chop the food item. There is no way to carry or drain the food item that has been chopped. A food chopping device that addresses these issues is desirable.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In a first aspect, a food chopping device is disclosed. The chopping device includes a chopping member having a pair of wings with each wing having a holding surface and a chopping edge. An angle of less than 180° is formed between the holding surfaces of the pair of wings. The chopping member also including an opening configured to drain a liquid from food. The food chopping device also includes a handle member attached with the chopping member.

### BRIEF DESCRIPTION OF THE DRAWINGS

FIG. 1 is a top perspective view of an embodiment of the food chopping device of the disclosure;

FIG. 2 is a bottom perspective view of the chopping device of FIG. 1;

FIG. 3 is a top plan view of the chopping device of FIG. 1;

FIG. 4 is a front elevational view of the chopping device of FIG. 1;

FIG. 5 is rear elevational view of the chopping device of FIG. 1.

### DESCRIPTION OF THE ILLUSTRATED EMBODIMENTS

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

Food chopping devices according to the present disclosure and their individual components may be variously configured without departing from the scope of the present disclosure.

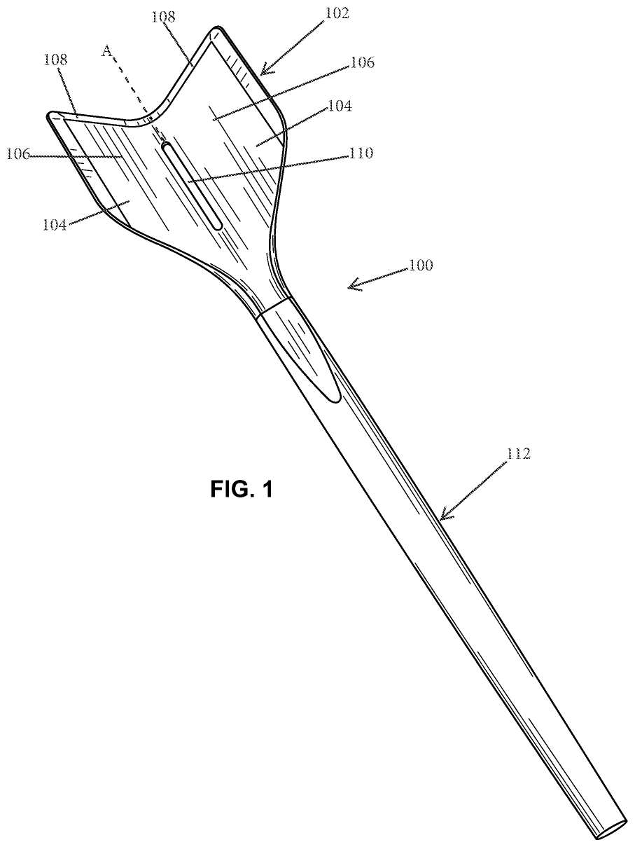

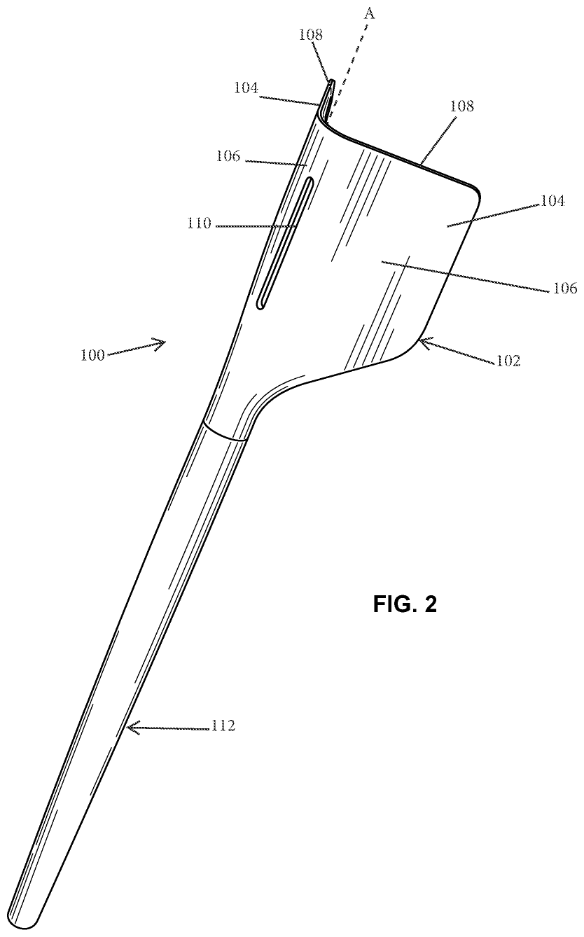

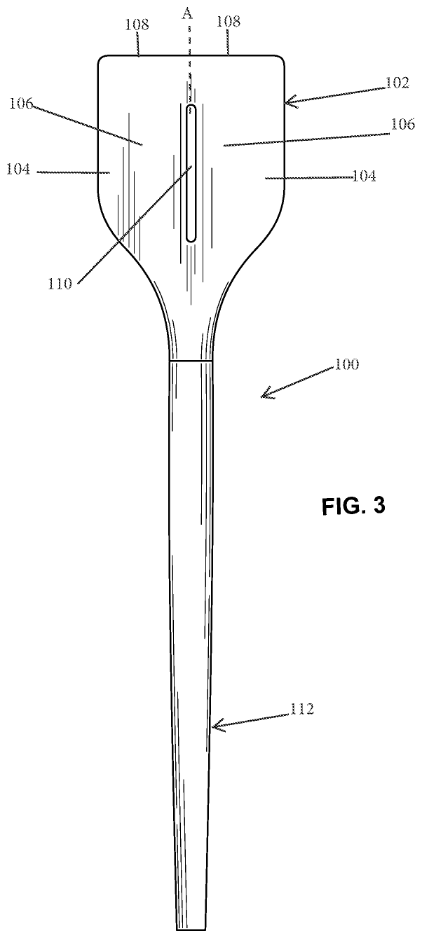

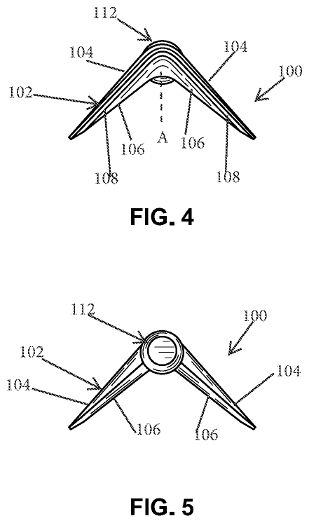

An embodiment of the food chopping device of the disclosure is indicated in general at 100 in FIGS. 1-5. The chopping device 100 has a chopping member 102 including a pair of wings 104 extending outwards from the longitudinal centerline or axis A of the device. Each wing 104 has a holding surface 106 and a chopping edge 108. The wings may have shapes other than those illustrated. The holding surfaces 106 are angled less than 180° from one another about axis A so as to be configured to hold and/or serve as a supporting surface for a food item. An obtuse angle, as illustrated, is preferable between the holding surfaces 106 of the wings 104. The configuration of the wings 104 and holding surfaces 106 of the chopping member 102 allows for the scooping and carrying of a chopped food item.

The chopping edge 108 may be any appropriate known edge type for cutting through food, including meat, poultry, game, pork, fish, and vegetables, such as a straight edge (illustrated) or a serrated edge.

When discussing the embodiments herein, meat may be used as the example for the food item that is chopped. Though the examples disclose a device that chops meat, any other suitable food item may be chopped in place of meat by the chopping device 100.

As shown in FIGS. 1-5, a handle member 112 is attached with the chopping member 102. The handle member 112 may be integrally molded with the chopping member 102. Alternatively, the handle member and the chopping member may be formed separately and then connected together with adhesive, fasteners or other means known in the art. In use, a user may grasp the handle member 112 and manipulate the chopping device 100 such that at least one edge 108 is positioned above, or at an angle to, the meat for chopping. After positioning the chopping member 102, the user moves the chopping member 102 toward the meat so that the edge 108 of the chopping member 102 penetrates and cuts or chops through the meat.

As shown most clearly in FIGS. 1-3, the chopping member 102 also includes an opening 110, configured to drain a liquid from food as it is held by the holding surfaces 106. The opening 110 is preferably positioned between the holding surfaces 106 of the pair of wings 104. As shown, the opening 110 may be positioned on the longitudinal centerline or axis A of the device. In alternative embodiments, the opening 110 may be positioned in any location on the holding surfaces 106 and may take a form other than the slot illustrated. For example, the opening may be round, oblong or square and/or may include multiple openings spread over one of both of the holding surfaces 106.

Because the holding surfaces 106 are biased toward the opening 110, liquid from the meat that drains onto the holding surfaces 106 while the device holds the meat moves toward and through the opening 110. As shown, the holding surfaces 106 may be smooth such that liquid more easily flows into the opening 110. In alternative embodiments flow paths may be defined in the holding surfaces to facilitate drainage of liquid toward the opening. Accordingly, when a piece of meat is positioned on the holding surfaces 106, liquids from the piece of meat including grease, juices, or blood, will flow into the opening 110 for drainage off of the holding surfaces. In alternative embodiments, where other food items are chopped, the liquid may be water, or any other liquids emanating from the food item.

As an example only, the chopping device 100 may be made out of a plastic. Examples of a plastic include polyvinylchloride (PVC) but other types of plastic may be used. Additionally, any other suitable materials known to a skilled person (for example, stainless steel) may be used to make the chopping device. After use, the chopping device 100 may be cleaned by any suitable known cleaning method, including with soap and water or in a dishwasher.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. A food chopping device comprising:
a chopping member including a pair of wings with each wing having a holding surface and a chopping edge, where an angle of less than 180° is formed between the holding surfaces of the pair of wings, said chopping member also including an opening configured to drain a liquid from a food item held by the holding surfaces; and
a handle member attached with the chopping member.

2. The food chopping device of claim 1 wherein the opening is a slot.

3. The food chopping device of claim 2 wherein the opening is positioned on a longitudinal centerline of the device.

4. The food chopping device of claim 3 wherein the holding surfaces are biased toward the opening such that liquid on the holding surfaces moves toward the opening.

5. The food chopping device of claim 1 wherein the opening is positioned on a longitudinal centerline of the device.

6. The food chopping device of claim 1 wherein the angle is obtuse.

7. The food chopping device of claim 1 wherein the food item is meat.

8. The food chopping device of claim 1 wherein the holding surfaces are biased toward the opening such that liquid on the holding surfaces moves toward the opening.

9. The food chopping device of claim 1 wherein the handle member is integrally molded with the chopping member.

10. The food chopping device of claim 9 wherein the handle and chopping member are made out of plastic.

11. The food chopping device of claim 1 wherein the handle member and the chopping member are separately formed, and the handle member is attached to the chopping member.

12. The food chopping device of claim 1 wherein the food chopping device is made out of a plastic.
